(19) United States
(12) Patent Application Publication
(10) Pub. No.: US 2026/0339295 A1
(43) Pub. Date: Oct. 29, 2026

(54) ENHANCED ADAPTER FOR DATA TRANSFER TO SERVE MULTIPLE WRITERS

(71) Applicant: Applied Materials, Inc., Santa Clara, CA (US)

(72) Inventors: Jin Seul Moon, Santa Clara, CA (US); Kuai Weng "Kevin" Cheong, Billerica, MA (US)

(73) Assignee: Applied Materials, Inc., Santa Clara, CA (US)

(21) Appl. No.: 19/192,770

(22) Filed: Apr. 29, 2025

(51) Int. Cl. G05B 19/4155

(52) U.S. Cl. CPC G05B 19/4155; G05B 2219/31372

(57) ABSTRACT

A system of advanced productivity family (APF) integrated with a manufacturing execution system (MES) is provided. The system includes an APF adapter installed on the MES, and a plurality of writers. The APF adapter is configured to: accept a connection request with a specific tag number from one of the plurality of writers; and send a tagged message corresponding to the specific tag number to the one of the plurality of writers. The one of the plurality of writers is configured to: send the connection request with the specific tag number to the APF adapter to establish a first connection with the APF adapter; and receive the tagged message corresponding to the specific tag number from the APF adapter.

### FIELD OF THE DISCLOSURE

The present disclosure relates generally to the advanced productivity family (APF) software and manufacturing execution system (MES) technology and, more specifically, to systems of enhanced adapter for data transfer to serve multiple writers and methods using thereof.

### BACKGROUND

The APF is a suite of fully integrated software components developed to improve the design, analysis, and event-by-event operation of complex manufacturing facilities. The APF can be targeted at solving multiple problems in manufacturing facilities. The APF can be employed for reporting and dispatching, factory automation, or a combination of these goals.

The APF may integrate with MES to gain access to real-time and historical information about the state of the manufacturing facility. This requires an APF adapter which are one or more components installed on a MES server that monitor data transactions from the MES and record those changes in tagged messages. These tagged messages are then sent to an APF server computer, where they are processed by various data transfer components. Generally, the tagged messages from the APF adapter are first processed by an APF writer which is a writer component of the APF, which archives the tagged messages before passing them on to other APF components for processing.

In existing technology, an APF adapter can connect to a single APF writer only. The APF adapter is being viewed as the single point of failure, and downtime is required when applying a patch to the APF and/or MES system. Therefore, there have a need of overcoming the above drawbacks to reduce downtime required for system patches and improve data transfer efficiency during writer downtimes or network issues.

### SUMMARY OF THE INVENTION

In one aspect, a system of advanced productivity family (APF) integrated with a manufacturing execution system (MES) is provided. The system includes an APF adapter installed on the MES, and a plurality of writers. The APF adapter is configured to: accept a connection request with a specific tag number from one of the plurality of writers; and send a tagged message corresponding to the specific tag number to the one of the plurality of writers. The one of the plurality of writers is configured to: send the connection request with the specific tag number to the APF adapter to establish a first connection with the APF adapter; and receive the tagged message corresponding to the specific tag number from the APF adapter.

In another aspect, a method is provided. The method can be implemented in a system of advanced productivity family (APF) integrated with a manufacturing execution system (MES) comprising an APF adapter installed on the MES and a plurality of writers. The method can include: sending, by one of the plurality of writers, a connection request with a specific tag number to the APF adapter to establish a first connection with the APF adapter; accepting, by the APF adapter, the connection request with the specific tag number from the one of the plurality of writers; sending, by the APF adapter, a tagged message corresponding to the specific tag number to the one of the plurality of writers; and receiving, by the one of the plurality of writers, the tagged message corresponding to the specific tag number from the APF adapter.

In yet another aspect, a non-transitory computer-readable medium is provided having computer-executable instructions stored thereon that, when executed by a system of advanced productivity family (APF) integrated with a manufacturing execution system (MES) comprising an APF adapter installed on the MES and a plurality of writers, cause the system to perform procedures comprising: sending, by one of the plurality of writers, a connection request with a specific tag number to the APF adapter to establish a first connection with the APF adapter; accepting, by the APF adapter, the connection request with the specific tag number from the one of the plurality of writers; sending, by the APF adapter, a tagged message corresponding to the specific tag number to the one of the plurality of writers; and receiving, by the one of the plurality of writers, the tagged message corresponding to the specific tag number from the APF adapter.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows.

FIG. 1 illustrates a schematic block diagram of a prior art system of APF integrated with MES in according to one embodiment of the present disclosure.

FIG. 2 illustrates a schematic block diagram of a disclosed system of APF integrated with MES in according to one embodiment of the present disclosure.

FIG. 3 illustrates a schematic comparison diagram of an example workflow of the system in FIG. 1 and an example workflow of the system in FIG. 2 according to one embodiment of the present disclosure.

FIG. 4 is a sequence flow diagram illustrating a possible sequence of events for performing data/message transfer between an APF adapter and multiple primary/combined writers according to one embodiment of the present disclosure.

FIG. 5 is a flow chart of a method for performing data/message transfer between an APF adapter and multiple primary/combined writers according to one embodiment of the present disclosure.

FIG. 6 is a flow chart of a method for performing data/message transfer between an APF adapter and multiple primary/combined writers from a perspective of the APF adapter according to one embodiment of the present disclosure.

FIG. 7 is a flow chart of a method for performing data/message transfer between an APF adapter and multiple primary/combined writers from a perspective of the primary/combined writer according to one embodiment of the present disclosure.

FIG. 8 is an example data transfer event for performing data/message transfer between an APF adapter and multiple primary/combined writers according to one embodiment of the present disclosure.

FIG. 9 illustrates an example computer system according to one embodiment of the present disclosure.

### DETAILED DESCRIPTION

The figures and the following description describe certain embodiments by illustration only. One skilled in the art will readily recognize from the following description that alternative embodiments of the systems, devices, structures and methods may be employed without departing from the principles described. Wherever practicable, similar or like reference numbers are used in the figures to indicate similar or like functionality. When elements share a common numeral followed by a different letter, the elements are similar or identical. A reference to the numeral alone generally refers to any one or any combination of such elements unless the context indicates otherwise.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

In a system of APF integrated with a MES, data transfer components of the APF can securely deliver the intercepted MES data/messages to the APF repository. The APF repository may be a proprietary temporal database, from which data is accessed by other APF components for reporting and dispatching.

The APF's reporting and dispatching architecture may include client applications, such as the APF formatter, the APF analytics editor, the APF analytics viewer, and the APF activity manager client. These client applications can be used to write, execute, and distribute reports about the state of a manufacturing facility.

To streamline dispatching in the manufacturing facility, rules can be created to be executed by an APF real-time dispatcher (APF RTD) to automate decisions. These rules can base on up-to-the-minute factory information. An APF RTD is a collection of components used to define and execute advanced rule-based, real-time dispatching strategies. Using the APF formatter, dispatching rules can be written in the same block-based interface used to develop APF reports. Similar to reports, executed dispatching rules used cached data read from the APF repository, rather than connecting to the MES database directly, so that rule execution and dispatching decisions do not affect MES response time.

In a manufacturing facility, the MES controls, coordinates, and monitors manufacturing processes. As stated, if an APF solution is designed to integrate with an MES, it includes a compatible APF adapter that includes one or more components installed on an MES server that monitor data transactions from the MES and record those changes in tagged messages. These messages are then sent to an APF server by data transfer components of the APF. An APF adapter is an APF server component that is installed on the MES server to monitor the data transactions from the MES. The APF adapter records data changes in tagged messages, and then sends them to data transfer components of the APF for processing, and for eventual inclusion in the APF repository. Generally, the tagged messages from the APF adapter are first processed by the APF writer component, which archives the messages before passing them on to other APF components for processing.

The APF writer can tag the intercepted MES messages and write them to a file of the APF for storage. The APF can use either one or two writers to transfer the intercepted MES data to the APF server. If two APF writers are used, they may be referred to as a primary APF writer (installed on the MES server) and a secondary APF writer (installed on the APF server). If only one APF writer is used, it may be referred as a combined APF writer and is installed on the APF server.

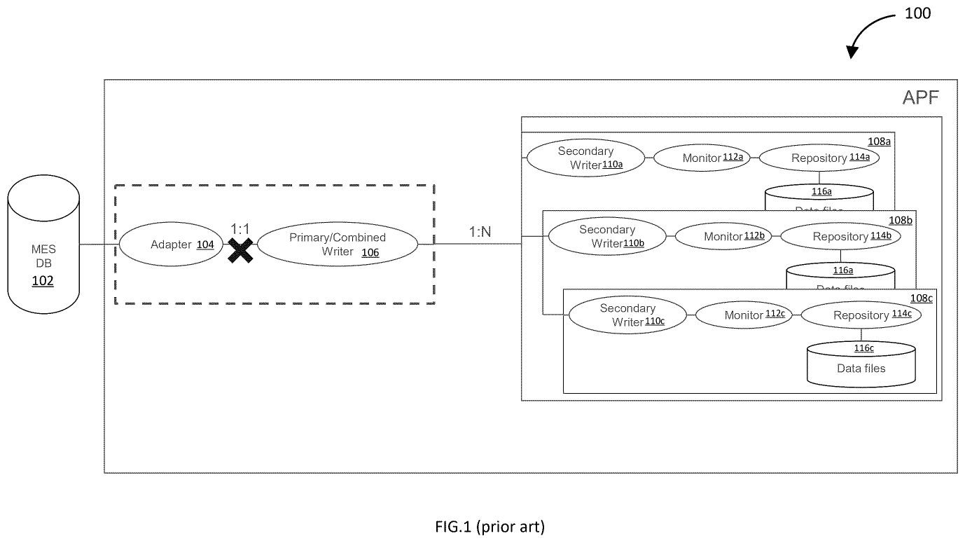

FIG. 1 illustrates a schematic block diagram of a prior art system 100 of APF integrated with MES in according to one embodiment of the present disclosure. The system 100 may comprise an MES database (DB) 102, an APF adapter 104, a primary/combined writer 106, and a plurality of component blocks such as 108a, 108b and 108c (which can be N number where the N can be any number equal to or greater than 1). Each of the plurality of component blocks may comprise a secondary writer, a monitor, a repository, and a storage storing data files. For example, the component block 108a may include a secondary writer 110a, a monitor 112a, a repository 114a, and a storage 116a storing data files. The above various components may be in data communication with one another through communication networks, such as wired networks, wireless networks, Internet, and so on.

As shown in FIG. 1, the APF adapter 104 connects to one primary/combined writer 106 only. That is, the APF adapter 104 connects to a single primary/combined writer 106. To connect the APF adapter 104 to the single primary/combined writer 106, the APF adapter 104 may identify the single primary/combined writer 106 by performing an operation programmed in an apf.xml file. For example, the operation may be written as Adapter-<writer_host> and <writer_port> in the apf.xml file. The APF adapter 104 may make a connection with the single primary/combined writer 106 based on <writer_host> and <writer_port>. The APF adapter 104 sends untagged messages, retrieved from the MES DB 102, to the single primary/combined writer 106. The single primary/combined writer 106 receives and tags the data (the untagged messages). If the APF adapter 104 fails to send data to the single primary/combined writer 106 such as when the single primary/combined writer 106 is down or due to network issues (indicated by a symbol “X” in FIG. 1), the APF adapter 104 retries infinitely or write the data into a recovery file depending on whether an <use_recovery> option is activated. The data may be retained in the queue table during the retries. The APF adapter 104 deletes data from the queue table when the data is either sent to the single primary/combined writer 106 or written in a recovery file. As used herein, a queue table is a table in the MES database. The queue table collects every MES transactional update for the APF adapter. Once an update is successfully fetched and archived (to the message buffer), it will be removed from the queue table by the APF adapter.

In some embodiments, in addition to a regular database (e.g., the MES database), the APF adapter can subscribe to publications from a data streaming broker, such as the Advanced Message Queuing Protocol (AMQP) or Kafka. There is no queue table in the data streaming, and also no deletion action of the data is involved.

As can be seen, in the system 100, the APF adapter 104 is being viewed as the single point of failure (indicated by a symbol “X” in FIG. 1). Production interruption can occur when the system 100 is offline for maintenance.

To overcome the above-mentioned drawbacks, the present disclosure provides an APF and MES system comprising an advanced APF adapter that can serve multiple APF primary/combined writers for data transfer. For simplicity, the advanced APF adapter disclosed herein is referred to as the APF adapter in the below description. The present disclosure can address the single point of failure in the prior art system, as discussed with respect to FIG. 1. The present disclosure can reduce downtime required for system patches and improve data transfer efficiency during the APF primary/combined writer downtimes or network issues. The present disclosure can ensure continuous operation, enhance reliability, and provide a more efficient data handling process by allowing multiple primary/combined writers to connect dynamically and request specific data points.

In the present disclosure, the APF adapter can send data to multiple primary/combined writers. The multiple primary/combined writers can dynamically request connections and specify a starting point for data transfer. The APF adapter can archive data and send it starting from the previous data point requested by the multiple primary/combined writers. The present disclosure can increase reliability by eliminating the single point of failure, reduce downtime as patches can be applied without stopping the entire system, and enhance data transfer efficiency and flexibility with dynamic connection requests and data archiving.

In some embodiments, the APF and MES system disclosed herein may provide a workflow as follows. The APF adapter may initiate a message buffer based on a specified size. The plurality of primary/combined writers may request connections with specific message/data tag numbers. The APF adapter may accept the connection requests and sends tagged messages starting from the requested tag. If the APF adapter fails to send data due to downtimes of one or more of the plurality of primary/combined writers or network issues, the APF adapter may close the connections to the downed primary/combined writers, and may continue to process data. When the one or more downed primary/combined writers is back online, the APF adapter can resend data from the requested tag. Data is always stored in the message buffers before sending, ensuring reliability and continuity.

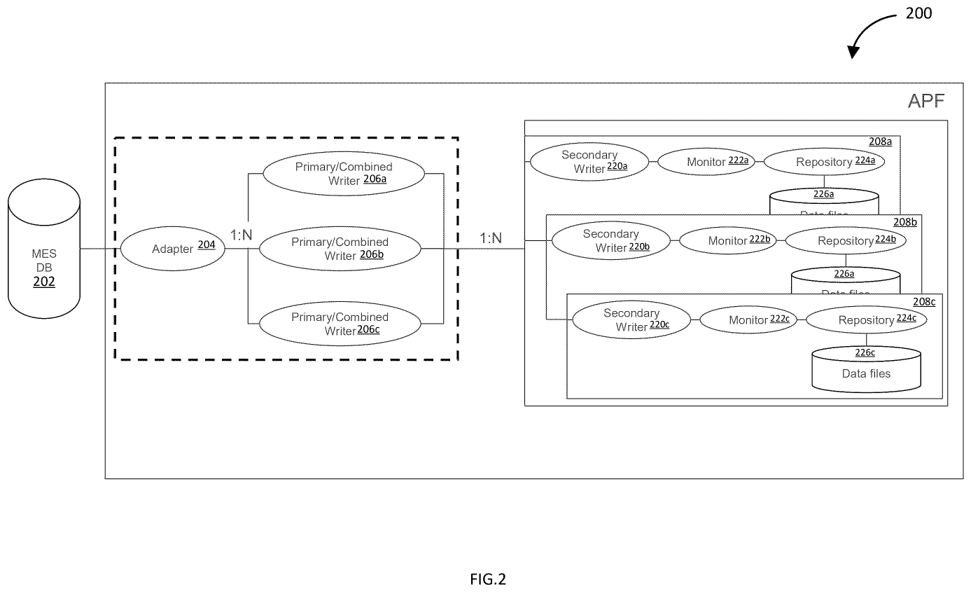

FIG. 2 illustrates a schematic block diagram of a disclosed system 200 of APF integrated with MES in according to one embodiment of the present disclosure. The system 200 may comprise an MES database (DB) 202, an APF adapter 204, a plurality of primary/combined writers (e.g., a primary/combined writers 206a, a primary/combined writer 206b, and a primary/combined writers 206c, which can be N number where the N can be any number equal to or greater than 1), and a plurality of component blocks such as 208a, 208b and 208c (which can be N number where the N can be any number equal to or greater than 1).

Each of the plurality of component blocks 208a, 208b and 208c may comprise a secondary writer, a monitor, a repository, and a storage storing data files. For example, the component block 208a may include a secondary writer 220a, a monitor 222a, a repository 224a, and a storage 226a storing data files. The above various components may be in data communication with one another through communication networks, such as wired networks, wireless networks, Internet, and so on. The monitor such as monitors 222a, 222b and 222c can be a software component that is configured to process data/messages received from each secondary writer (220a, 220b and 220c). In some embodiments, the monitors 222a, 222b and 222c can be configured to connect to a same secondary writer 220a, 220b or 220c. In some other embodiments, each of the monitors 222a, 222b and 222c can be configured to connect to one secondary writer 220a, 220b or 220c on a one-to-one base.

As can be seen, the APF architecture disclosed in the system 200 can be built without single points of failure. With one APF adapter 204 connecting to a plurality of primary/combined writers (e.g., 1 to N), data can continue to flow even when some systems/components are taken offline for maintenance.

In the system 200, the APF adapter 204 can send data to a plurality of primary/combined writers. Each of the plurality of primary/combined writers can request a connection to the APF adapter 204, and the APF adapter 204 can accept it dynamically. Each of the plurality of primary/combined writers can request a starting point of data. the APF adapter 204 can archive data and send to the corresponding primary/combined writer starting from the previous data.

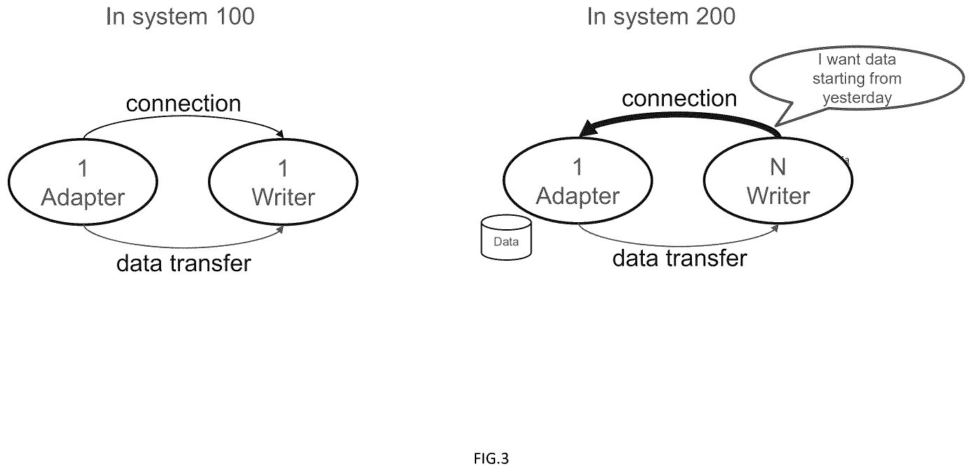

FIG. 3 illustrates a schematic comparison diagram of an example workflow of the system 100 and an example workflow of the system 200 according to one embodiment of the present disclosure. As shown, the one APF adapter of the system 100 makes a connection to the one primary/combined writer of the system 100, and then the one APF adapter of the system 100 transfers data to the one primary/combined writer of the system 100. In the system 200, each of the N primary/combined writers of the system 200 can request a connection to the one APF adapter of the system 200, and the one APF adapter of the system 200 can accept it dynamically. The one APF adapter of the system 200 can transfer data to the N primary/combined writers of the system 200. Further, when each of the N primary/combined writers of the system 200 is requesting a connection to the one APF adapter of the system 200, each of the N primary/combined writers of the system 200 can request a data starting point, such as starting data from yesterday.

In the system 200, the APF adapter can archives data for subsequent requests from the N primary/combined writers. Each of the N primary/combined writers can request the desired tag number from the APF adapter when necessary.

In some embodiments, the APF adapter may store data/messages in a message buffer before transmitting the data to the N primary/combined writers. A message buffer is a file where the APF adapter writes data to disk. The message buffer is used to maintain data integrity, ensuring that no data is lost or corrupted during transfer. The message buffer can allow the system 200 to restart from a specific data point, providing flexibility in case of interruptions or failures.

In some embodiments, the APF adapter can provide an automatic archive feature for disk space management. It controls its disk space used by the message buffer archives by: limiting the number of message buffer archive sub-directories, limiting the duration a message buffer is stored in disk, limiting the free disk percentage, and/or compressing the message buffer archives.

In the system 200, the required option elements in an apf.xml file can have the following format: Adapter <message_buffer_size>, and Writer <adapters>. The “Adapter <writer_host> & <writer_port>” as used in the system 100 is no longer needed in the system 200.

When the APF adapter starts in the system 200, the APF adapter can be provided with a startup argument: start_tag [tag_no], which can specify the starting tag number. When each of the N primary/combined writers starts in the system 200, each of the N primary/combined writers can be provided with startup arguments: start_with_first_tag (to start fetching from the first available tag in the upstream connection), and start_with_last_tag (to start fetching from the next tag present in the upstream connection).

In some embodiments, an example workflow in the system 200 can be as follows. The APF adapter initiates a message buffer based on <message_buffer_size>. A primary/combined writer of the plurality (N) of primary/combined writers requests a connection with a specific tag number to the APF adapter based on <adapters>. The APF adapter accepts the connection request from the primary/combined writer. The APF adapter sends tagged messages to the primary/combined writer, starting with the requested tag. The APF adapter reads the tagged message from message buffers before sending the tagged message to the primary/combined writer. The primary/combined writer receives the data. If the APF adapter fails to send data to the primary/combined writer such as when the primary/combined writer is down or due to network issues, the APF adapter closes the connection and continue to process data. When the primary/combined writer is back online and requests a connection again, the APF adapter resends data from the requested tag. The APF adapter deletes data from the queue table regardless of whether data is sent successfully. The data is always stored in the message buffers before sending.

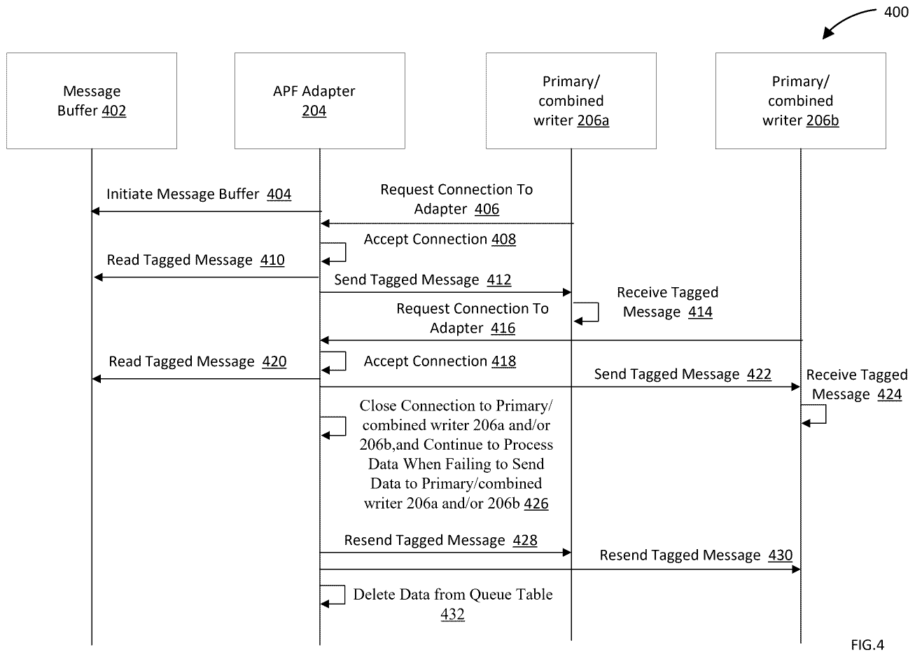

FIG. 4 is a sequence flow diagram 400 illustrating a possible sequence of events for performing data/message transfer between an APF adapter and multiple primary/combined writers according to some embodiments. This sequence flow diagram 400 provides one example of how an APF adapter and multiple primary/combined writers of the system 200 is performed.

At step 404, the APF adapter 204 initiates a message buffer 402 based on <message_buffer_size>. At step 406, a primary/combined writer 206a of the plurality (N) of primary/combined writers, requests a connection with a specific tag number to the APF adapter 204 based on <adapters>. At step 408, the APF adapter 204 accepts the connection request from the primary/combined writer 206a. At step 410, the APF adapter 204 reads the tagged message from the message buffer 402 before sending the tagged message to the primary/combined writer. At step 412, the APF adapter 204 sends the tagged messages to the primary/combined writer 206a, starting with the requested tag. At step 414, the primary/combined writer 206a receives the data (i.e., the requested tagged message).

Similarly, at step 416, a primary/combined writer 206b of the plurality (N) of primary/combined writers, requests a connection with a specific tag number to the APF adapter 204 based on <adapters>. At step 418, the APF adapter 204 accepts the connection request from the primary/combined writer 206b. At step 420, the APF adapter 204 reads the tagged message from the message buffer 402 before sending the tagged message to the primary/combined writer. At step 422, the APF adapter 204 sends the tagged messages to the primary/combined writer 206b, starting with the requested tag. At step 424, the primary/combined writer 206b receives the data (i.e., the requested tagged message).

In FIG. 4, only two primary/combined writers are shown for illustrative purposes, and the present disclosure is not limited thereto. Any number of the primary/combined writers can be included in FIG. 4.

In some embodiments, if the APF adapter 204 fails to send data to the primary/combined writer 206a and/or 206b, such as when the primary/combined writer 206a and/or 206b is down or due to network issues, at step 426, the APF adapter 204 closes the connection and continue to process data. At steps 428 and 430, when the primary/combined writer 206a and/or 206b is back online and requests a connection again, the APF adapter 204 resends data from the requested tag. At step 432, the APF adapter 204 deletes data from the queue table regardless of whether data is sent successfully. The data is always stored in the message buffers before sending.

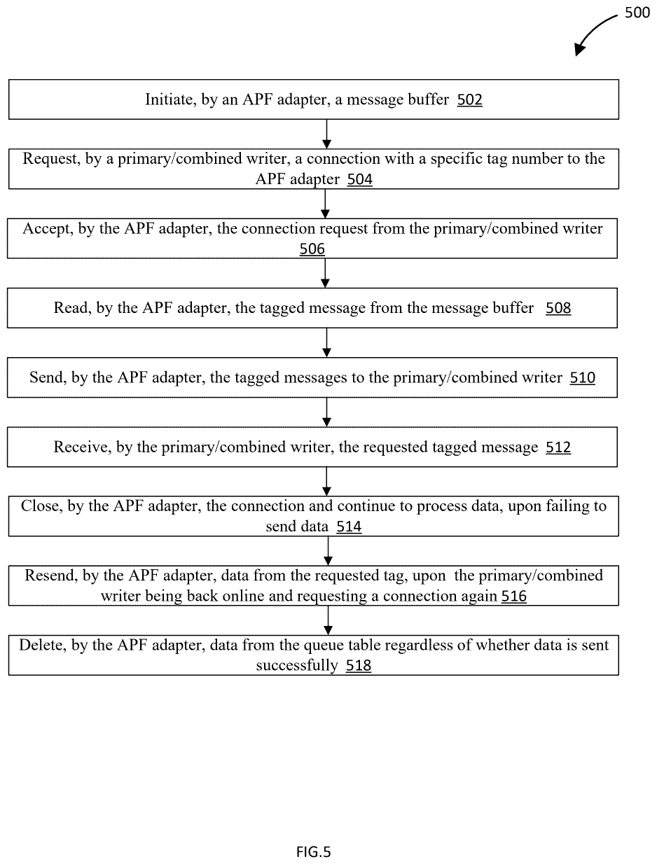

FIG. 5 is a flow chart of a method 500 for performing data/message transfer between an APF adapter and multiple primary/combined writers according to some embodiments. This method 500 provides one example of how an APF adapter and multiple primary/combined writers of the system 200 is performed. In FIG. 5, only one primary/combined writer is described for illustrative purposes, and the method 500 is not limited thereto. Any number of the primary/combined writers can be included in the method 500.

At step 502, the APF adapter initiates a message buffer based on <message_buffer_size>. At step 504, a primary/combined writer of the plurality (N) of primary/combined writers, requests a connection with a specific tag number to the APF adapter based on <adapters>. At step 506, the APF adapter accepts the connection request from the primary/combined writer. At step 508, the APF adapter reads the tagged message from the message buffer before sending the tagged message to the primary/combined writer. At step 510, the APF adapter sends the tagged messages to the primary/combined writer, starting with the requested tag. At step 512, the primary/combined writer receives the data (i.e., the requested tagged message).

In some embodiments, if the APF adapter fails to send data to the primary/combined writer, such as when the primary/combined writer is down or due to network issues, at step 514, the APF adapter closes the connection and continue to process data. At step 516, when the primary/combined writer is back online and requests a connection again, the APF adapter resends data from the requested tag. At step 518, the APF adapter deletes data from the queue table regardless of whether data is sent successfully. The data is always stored in the message buffers before sending.

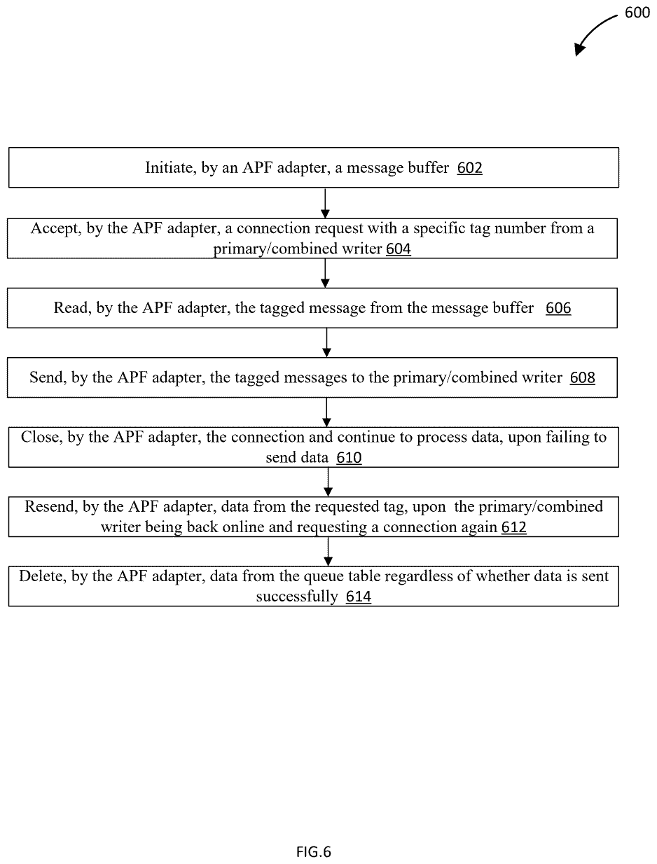

FIG. 6 is a flow chart of a method 600 for performing data/message transfer between an APF adapter and multiple primary/combined writers according to some embodiments. This method 600 provides one example of how an APF adapter and multiple primary/combined writers of the system 200 is performed from a perspective of the APF adapter. In FIG. 6, only one primary/combined writer is described for illustrative purposes, and the method 600 is not limited thereto. Any number of the primary/combined writers can be included in the method 600.

At step 602, the APF adapter initiates a message buffer based on <message_buffer_size>. At step 604, the APF adapter accepts a connection request with a specific tag number from a primary/combined writer. At step 606, the APF adapter reads the tagged message from the message buffer before sending the tagged message to the primary/combined writer. At step 608, the APF adapter sends the tagged messages to the primary/combined writer, starting with the requested tag.

In some embodiments, if the APF adapter fails to send data to the primary/combined writer, such as when the primary/combined writer is down or due to network issues, at step 610, the APF adapter closes the connection and continue to process data. At step 612, when the primary/combined writer is back online and requests a connection again, the APF adapter resends data from the requested tag. At step 614, the APF adapter deletes data from the queue table regardless of whether data is sent successfully. The data is always stored in the message buffers before sending.

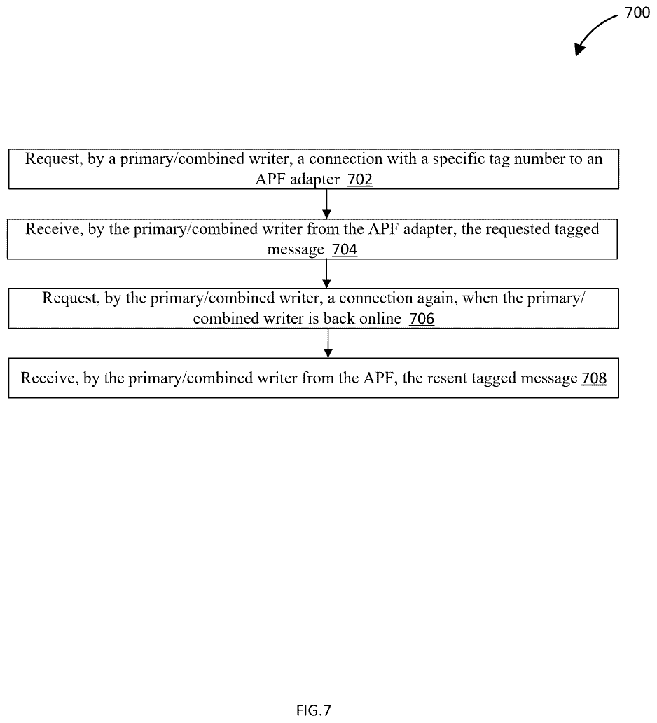

FIG. 7 is a flow chart of a method 700 for performing data/message transfer between an APF adapter and multiple primary/combined writers according to some embodiments. This method 700 provides one example of how an APF adapter and multiple primary/combined writers of the system 200 is performed from a perspective of the primary/combined writer. In FIG. 7, only one primary/combined writer is described for illustrative purposes, and the method 700 is not limited thereto. Any number of the primary/combined writers can be included in the method 700.

At step 702, a primary/combined writer of the plurality (N) of primary/combined writers, requests a connection with a specific tag number to an APF adapter based on <adapters>. The APF adapter accepts the connection request from the primary/combined writer. The APF adapter reads the tagged message from the message buffer before sending the tagged message to the primary/combined writer. The APF adapter sends the tagged messages to the primary/combined writer, starting with the requested tag. At step 704, the primary/combined writer receives the data (i.e., the requested tagged message).

In some embodiments, if the APF adapter fails to send data to the primary/combined writer, such as when the primary/combined writer is down or due to network issues. The APF adapter closes the connection and continue to process data. At step 706, the primary/combined writer is back online and requests a connection again, the APF adapter resends data from the requested tag. At step 708, the primary/combined writer receives the resent tagged message.

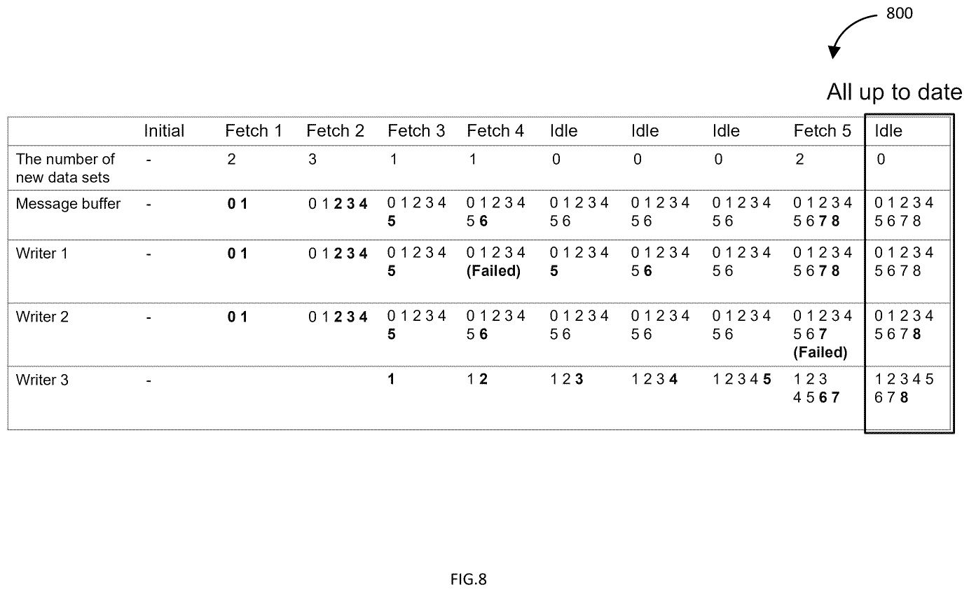

FIG. 8 is an example data transfer event 800 for performing data/message transfer between an APF adapter and multiple primary/combined writers according to some embodiments. This data transfer event 800 provides one example of how an APF adapter and multiple primary/combined writers of the system 200 perform data transfer. In FIG. 8, only three primary/combined writer are described for illustrative purposes, and the data transfer event 800 is not limited thereto. Any number of the primary/combined writers can be included in the data transfer event 800.

As shown in FIG. 8, for the Fetch 1 performed by the APF adapter, there have two new data sets, tagged as 0 and 1 respectively, in the message buffer. The primary/combined writers 1 and 2 receive the two new data sets, while the primary/combined writer 3 is offline and does not receive the two new data sets.

For the Fetch 2 performed by the APF adapter, there have three additional new data sets, tagged as 2, 3 and 4 respectively, in the message buffer. The primary/combined writers 1 and 2 receive the three new data sets, while the primary/combined writer 3 is offline and does not receive the three new data sets.

For the Fetch 3 performed by the APF adapter, there have one additional new data set, tagged as 5, in the message buffer. The primary/combined writers 1 and 2 receive the one new data set, while the primary/combined writer 3 goes online and requests tagged messages starting at tag 1.

For the Fetch 4 performed by the APF adapter, there have one additional new data set, tagged as 6, in the message buffer. The primary/combined writer 1 failed to receive the one new data, which may be because the primary/combined writer 1 is offline. The primary/combined writer 2 receives the one new data set, while the primary/combined writer 3 receives one old message tagged as 2.

For the first idle period, there have no additional new data set in the message buffer. The primary/combined writer 1 is back online to receive the data tagged as 5 from which the primary/combined writer 1 failed from the fetch 4. The primary/combined writer 2 does not receive any data set, while the primary/combined writer 3 receives one old message tagged as 3.

For the second idle period, there have no additional new data set in the message buffer. The primary/combined writer 1 receives the data tagged as 6. The primary/combined writer 2 does not receive any data set, while the primary/combined writer 3 receives one old message tagged as 4.

For the third idle period, there have no additional new data set in the message buffer. The primary/combined writers 1 and 2 do not receive any data set, while the primary/combined writer 3 receives one old message tagged as 5.

For the Fetch 5 performed by the APF adapter, there have two additional new data sets, tagged as 7 and 8 respectively, in the message buffer. The primary/combined writer 1 receives the two new data sets, the primary/combined writer 2 receives one of the two new data sets (tagged as 7) while failed to receive the new data set tagged as 8, and the primary/combined writer 3 receives one old data set tagged as 6 and one new data set tagged as 7.

For the fourth idle period, there have no additional new data set in the message buffer. The primary/combined writer 1 does not receive any data set, the primary/combined writer 2 receives an old data set tagged as 8 from which it failed to fetch during the fetch 5, and the primary/combined writer 3 receives one old message tagged as 8. At this moment, all three of the primary/combined writers received all the data sets stored in the message buffer. That is, all three of the primary/combined writers are up to date.

In some embodiments, an APF adapter disclosed can be configured to connect to multiple primary/combined writers as follows: (1) specify <message_buffer_size> element in an Adapter configuration to enable message buffer feature, and (2) specify <adapters> in each individual primary/combined writer configuration. The APF adapter needs to retain the historical data and accepts connection requests from the multiple primary/combined writers to initiate data transfer from a specific tag because a primary/combined writer can be taken offline for platform maintenance and reconnects to catch up. The message buffer feature can be enabled using the <message_buffer_size> option in the Adapter's apf.xml configuration. When The message buffer feature is enabled, the Adapter's start-tag startup argument can be used to create and initialize a new message buffer and specify the staring tag number of the message buffer. The Adapter's status-tag status tool command can be used to display the tag number of the first message in the Adapter's available message buffer, as well as the tag number of the next message to be written o the message buffer. Tag number can also be synchronized when initializing a message buffer.

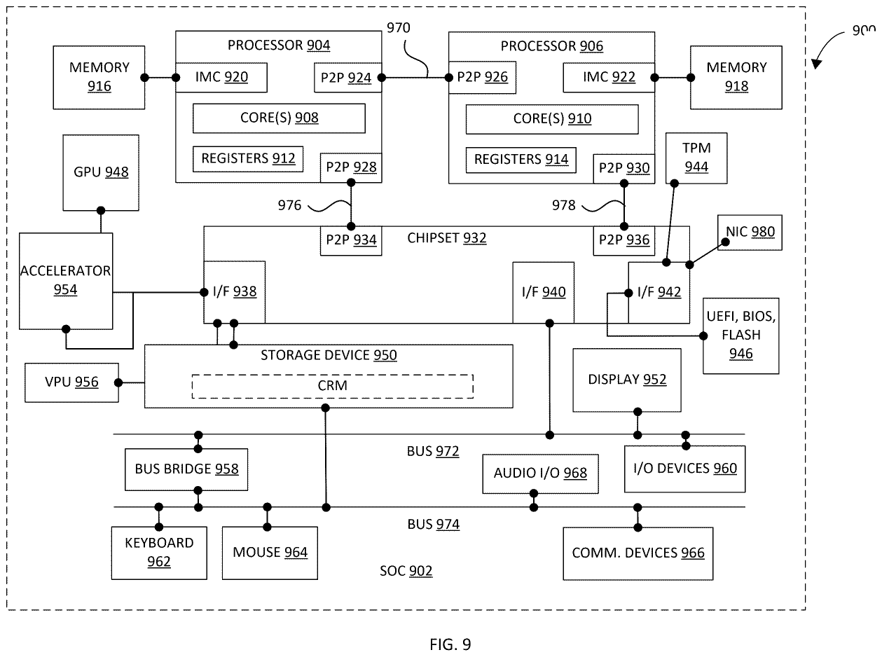

FIG. 9 illustrates an embodiment of a computing architecture 900. Computing architecture 900 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 900 has a single processor with one core or more than one processor. Note that the term “processor” refers to a processor with a single core or a processor package with multiple processor cores. In at least one embodiment, the computing architecture 900 is representative of the components of the systems 100 and 200. More generally, the computing architecture 900 is configured to implement all logic, systems, logic flows, methods, apparatuses, and functionality described herein with reference to previous figures. The computing architecture 900 can be used in the systems and methods disclosed herein for performing various functions, such as the MES database, the adapters, the primary/combined writers, the second writers, the monitors, the repository, the data store for storing data files.

As used in this application, the terms “system” and “component” and “module” are intended to refer to a computer-related entity, either hardware, a combination of hardware and software, software, or software in execution, examples of which are provided by the exemplary computing architecture 900. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 9, computing architecture 900 comprises a system-on-chip (SoC) 902 for mounting platform components. System-on-chip (SoC) 902 is a point-to-point (P2P) interconnect platform that includes a first processor 904 and a second processor 906 coupled via a point-to-point interconnect 970 such as an Ultra Path Interconnect (UPI). In other embodiments, the computing architecture 900 is another bus architecture, such as a multi-drop bus. Furthermore, each of processor 904 and processor 906 are processor packages with multiple processor cores including core(s) 908 and core(s) 910, respectively. While the computing architecture 900 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 904 and chipset 932. Some platforms include additional components and some platforms include sockets to mount the processors and/or the chipset. Furthermore, some platforms do not have sockets (e.g. SoC, or the like). Although depicted as a SoC 902, one or more of the components of the SoC 902 are included in a single die package, a multi-chip module (MCM), a multi-die package, a chiplet, a bridge, and/or an interposer. Therefore, embodiments are not limited to a SoC.

The processor 904 and processor 906 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM® and Sony® Cell processors; and similar processors. Dual microprocessors, multi-core processors, and other multi-processor architectures are also employed as the processor 904 and/or processor 906. Additionally, the processor 904 need not be identical to processor 906.

Processor 904 includes an integrated memory controller (IMC) 920 and point-to-point (P2P) interface 924 and P2P interface 928. Similarly, the processor 906 includes an IMC 922 as well as P2P interface 926 and P2P interface 930. IMC 920 and IMC 922 couple the processor 904 and processor 906, respectively, to respective memories (e.g., memory 916 and memory 918). Memory 916 and memory 918 are portions of the main memory (e.g., a dynamic random-access memory (DRAM)) for the platform such as double data rate type 4 (DDR4) or type 5 (DDR5) synchronous DRAM (SDRAM). In the present embodiment, the memory 916 and the memory 918 locally attach to the respective processors (i.e., processor 904 and processor 906). In other embodiments, the main memory couple with the processors via a bus and shared memory hub. Processor 904 includes registers 912 and processor 906 includes registers 914.

Computing architecture 900 includes chipset 932 coupled to processor 904 and processor 906. Furthermore, chipset 932 are coupled to storage device 950, for example, via an interface (I/F) 938. The I/F 938 may be, for example, a Peripheral Component Interconnect-enhanced (PCIe) interface, a Compute Express Link® (CXL) interface, or a Universal Chiplet Interconnect Express (UCIe) interface. Storage device 950 stores instructions executable by circuitry of computing architecture 900 (e.g., processor 904, processor 906, GPU 948, accelerator 954, vision processing unit 956, or the like).

Processor 904 couples to the chipset 932 via P2P interface 928 and P2P 934 while processor 906 couples to the chipset 932 via P2P interface 930 and P2P 936. Direct media interface (DMI) 976 and DMI 978 couple the P2P interface 928 and the P2P 934 and the P2P interface 930 and P2P 936, respectively. DMI 976 and DMI 978 is a high-speed interconnect that facilitates, e.g., eight Giga Transfers per second (GT/s) such as DMI 3.0. In other embodiments, the processor 904 and processor 906 interconnect via a bus.

The chipset 932 comprises a controller hub such as a platform controller hub (PCH). The chipset 932 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 932 comprises more than one controller hub such as a chipset with a memory controller hub, a graphics controller hub, and an input/output (I/O) controller hub.

In the depicted example, chipset 932 couples with a trusted platform module (TPM) 944 and UEFI, BIOS, FLASH circuitry 946 via I/F 942. The TPM 944 is a dedicated microcontroller designed to secure hardware by integrating cryptographic keys into devices. The UEFI, BIOS, FLASH circuitry 946 may provide pre-boot code. The I/F 942 may also be coupled to a network interface circuit (NIC) 980 for connections off-chip.

Furthermore, chipset 932 includes the I/F 938 to couple chipset 932 with a high-performance graphics engine, such as, graphics processing circuitry or a graphics processing unit (GPU) 948. In other embodiments, the computing architecture 900 includes a flexible display interface (FDI) (not shown) between the processor 904 and/or the processor 906 and the chipset 932. The FDI interconnects a graphics processor core in one or more of processor 904 and/or processor 906 with the chipset 932.

The computing architecture 900 is operable to communicate with wired and wireless devices or entities via the network interface (NIC) 90 using the IEEE 802 family of standards, such as wireless devices operatively disposed in wireless communication (e.g., IEEE 802.9 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.9x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 954 and/or vision processing unit 956 are coupled to chipset 932 via I/F 938. The accelerator 954 is representative of any type of accelerator device (e.g., a data streaming accelerator, cryptographic accelerator, cryptographic co-processor, an offload engine, etc.). One example of an accelerator 954 is the Intel® Data Streaming Accelerator (DSA). The accelerator 954 is a device including circuitry to accelerate copy operations, data encryption, hash value computation, data comparison operations (including comparison of data in memory 916 and/or memory 918), and/or data compression. Examples for the accelerator 954 include a USB device, PCI device, PCIe device, CXL device, UCIe device, and/or an SPI device. The accelerator 954 also includes circuitry arranged to execute machine learning (ML) related operations (e.g., training, inference, etc.) for ML models. Generally, the accelerator 954 is specially designed to perform computationally intensive operations, such as hash value computations, comparison operations, cryptographic operations, and/or compression operations, in a manner that is more efficient than when performed by the processor 904 or processor 906. Because the load of the computing architecture 900 includes hash value computations, comparison operations, cryptographic operations, and/or compression operations, the accelerator 954 greatly increases performance of the computing architecture 900 for these operations.

The accelerator 954 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 954. For example, the accelerator 954 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 954 via a non-posted write (e.g., a deferred memory write (DMWr)). One example of an instruction that atomically submits a work descriptor to the shared work queue of the accelerator 954 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 954. The dedicated work queue may accept job submissions via commands such as the movdir64b instruction.

Various I/O devices 960 and display 952 couple to the bus 972, along with a bus bridge 958 which couples the bus 972 to a second bus 974 and an I/F 940 that connects the bus 972 with the chipset 932. In one embodiment, the second bus 974 is a low pin count (LPC) bus. Various input/output (I/O) devices couple to the second bus 974 including, for example, a keyboard 962, a mouse 964 and communication devices 966.

Furthermore, an audio I/O 968 couples to second bus 974. Many of the I/O devices 960 and communication devices 966 reside on the system-on-chip (SoC) 902 while the keyboard 962 and the mouse 964 are add-on peripherals. In other embodiments, some or all the I/O devices 960 and communication devices 966 are add-on peripherals and do not reside on the system-on-chip (SoC) 902.

The various components of the disclosed systems can communicate information between each other using a communication framework. The communication framework implements any well-known communications techniques and protocols. The communication framework is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by computer clients and computer servers. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

In some embodiments, a system of advanced productivity family (APF) integrated with a manufacturing execution system (MES) is provided. The system includes an APF adapter installed on the MES, and a plurality of writers. The APF adapter is configured to: accept a connection request with a specific tag number from one of the plurality of writers; and send a tagged message corresponding to the specific tag number to the one of the plurality of writers. The one of the plurality of writers is configured to: send the connection request with the specific tag number to the APF adapter to establish a first connection with the APF adapter; and receive the tagged message corresponding to the specific tag number from the APF adapter. The APF adapter can be further configured to initiate a message buffer. The APF adapter can be further configured to read the tagged message corresponding to the specific tag number from the message buffer. Upon failing to send the tagged message, the APF adapter can be further configured to close the first connection. The APF adapter can be further configured to resend the tagged message upon the one of the plurality of writers being back online and requesting a second connection. The APF adapter can be further configured to delete the tagged message from a queue table. The one of the plurality of writers can be further configured to request a second connection with the APF adapter when the one of the plurality of writers is back online from offline. The one of the plurality of writers can be further configured to receive the tagged message resent by the APF adapter.

In some embodiments, a method is provided. The method can be implemented in a system of advanced productivity family (APF) integrated with a manufacturing execution system (MES) comprising an APF adapter installed on the MES and a plurality of writers. The method can include: sending, by one of the plurality of writers, a connection request with a specific tag number to the APF adapter to establish a first connection with the APF adapter; accepting, by the APF adapter, the connection request with the specific tag number from the one of the plurality of writers; sending, by the APF adapter, a tagged message corresponding to the specific tag number to the one of the plurality of writers; and receiving, by the one of the plurality of writers, the tagged message corresponding to the specific tag number from the APF adapter. The method can further include initiating, by the APF adapter, a message buffer. The method can further include reading, by the APF adapter, the tagged message corresponding to the specific tag number from the message buffer. The method can further include, upon failing to send the tagged message, closing, by the APF adapter, the first connection. The method can further include resending, by the APF adapter, the tagged message upon the one of the plurality of writers being back online and requesting a second connection. The method can further include deleting, by the APF adapter, the tagged message from a queue table. The method can further include requesting, by the one of the plurality of writers, a second connection with the APF adapter when the one of the plurality of writers is back online from offline. The method can further include receiving, by the one of the plurality of writers, the tagged message resent by the APF adapter.

In some embodiments, a non-transitory computer-readable medium is provided having computer-executable instructions stored thereon that, when executed by a system of advanced productivity family (APF) integrated with a manufacturing execution system (MES) comprising an APF adapter installed on the MES and a plurality of writers, cause the system to perform procedures comprising: sending, by one of the plurality of writers, a connection request with a specific tag number to the APF adapter to establish a first connection with the APF adapter; accepting, by the APF adapter, the connection request with the specific tag number from the one of the plurality of writers; sending, by the APF adapter, a tagged message corresponding to the specific tag number to the one of the plurality of writers; and receiving, by the one of the plurality of writers, the tagged message corresponding to the specific tag number from the APF adapter. The procedures further comprise initiating, by the APF adapter, a message buffer. The procedures further comprise reading, by the APF adapter, the tagged message corresponding to the specific tag number from the message buffer. The procedures further comprise, upon failing to send the tagged message, closing, by the APF adapter, the first connection.

The various elements of systems as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the systems described above may be implemented using any combination of discrete circuitry, application specific integrated circuits (ASICs), logic gates and/or single chip architectures. Further, the features of the systems may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A system of advanced productivity family (APF) integrated with a manufacturing execution system (MES), comprising:
an APF adapter installed on the MES; and
a plurality of writers,
wherein:
the APF adapter is configured to:
accept a connection request with a specific tag number from one of the plurality of writers; and
send a tagged message corresponding to the specific tag number to the one of the plurality of writers, and
the one of the plurality of writers is configured to:
send the connection request with the specific tag number to the APF adapter to establish a first connection with the APF adapter; and
receive the tagged message corresponding to the specific tag number from the APF adapter.

2. The system of claim 1, wherein the APF adapter is further configured to initiate a message buffer.

3. The system of claim 2, wherein the APF adapter is further configured to read the tagged message corresponding to the specific tag number from the message buffer.

4. The system of claim 1, wherein upon failing to send the tagged message, the APF adapter is further configured to close the first connection.

5. The system of claim 4, wherein the APF adapter is further configured to resend the tagged message upon the one of the plurality of writers being back online and requesting a second connection.

6. The system of claim 1, wherein the APF adapter is further configured to delete the tagged message from a queue table.

7. The system of claim 1, wherein the one of the plurality of writers is further configured to request a second connection with the APF adapter when the one of the plurality of writers is back online from offline.

8. The system of claim 7, wherein the one of the plurality of writers is further configured to receive the tagged message resent by the APF adapter.

9. A method implemented in a system of advanced productivity family (APF) integrated with a manufacturing execution system (MES) comprising an APF adapter installed on the MES and a plurality of writers, the method comprising:
sending, by one of the plurality of writers, a connection request with a specific tag number to the APF adapter to establish a first connection with the APF adapter;
accepting, by the APF adapter, the connection request with the specific tag number from the one of the plurality of writers;
sending, by the APF adapter, a tagged message corresponding to the specific tag number to the one of the plurality of writers; and
receiving, by the one of the plurality of writers, the tagged message corresponding to the specific tag number from the APF adapter.

10. The method of claim 9, further comprising initiating, by the APF adapter, a message buffer.

11. The method of claim 10, further comprising reading, by the APF adapter, the tagged message corresponding to the specific tag number from the message buffer.

12. The method of claim 9, further comprising, upon failing to send the tagged message, closing, by the APF adapter, the first connection.

13. The method of claim 12, further comprising resending, by the APF adapter, the tagged message upon the one of the plurality of writers being back online and requesting a second connection.

14. The method of claim 9, further comprising deleting, by the APF adapter, the tagged message from a queue table.

15. The method of claim 9, further comprising requesting, by the one of the plurality of writers, a second connection with the APF adapter when the one of the plurality of writers is back online from offline.

16. The method of claim 15, further comprising receiving, by the one of the plurality of writers, the tagged message resent by the APF adapter.

17. A non-transitory computer-readable medium having computer-executable instructions stored thereon that, when executed by a system of advanced productivity family (APF) integrated with a manufacturing execution system (MES) comprising an APF adapter installed on the MES and a plurality of writers, cause the system to perform procedures comprising:
sending, by one of the plurality of writers, a connection request with a specific tag number to the APF adapter to establish a first connection with the APF adapter;
accepting, by the APF adapter, the connection request with the specific tag number from the one of the plurality of writers;
sending, by the APF adapter, a tagged message corresponding to the specific tag number to the one of the plurality of writers; and
receiving, by the one of the plurality of writers, the tagged message corresponding to the specific tag number from the APF adapter.

18. The non-transitory computer-readable medium of claim 17, the procedures further comprise initiating, by the APF adapter, a message buffer.

19. The non-transitory computer-readable medium of claim 18, the procedures further comprise reading, by the APF adapter, the tagged message corresponding to the specific tag number from the message buffer.

20. The non-transitory computer-readable medium of claim 17, the procedures further comprise, upon failing to send the tagged message, closing, by the APF adapter, the first connection.
